(19) United States
(12) Patent Application Publication
(10) Pub. No.: US 2008/0054217 A1
(43) Pub. Date: Mar. 6, 2008

(54) Heat transport fluid, heat transport structure, and heat transport method

(75) Inventors: Yoshimasa Hijikata, Nishikamo-gun (JP); Eiichi Torigoe, Anjo-city (JP); Touru Kawaguchi, Kariya-city (JP); Toshiyuki Morishita, Kagoya-city (JP)

Correspondence Address: HARNESS, DICKEY & PIERCE, P.L.C., P.O. BOX 828, BLOOMFIELD HILLS, MI, 48303, US

(73) Assignee: DENSO Corporation, Kariya-city (JP)

(21) Appl. No.: 11/899,387

(22) Filed: Sep. 5, 2007

(30) Foreign Application Priority Data
Sep. 6, 2006 (JP) 2006-241582

(51) Int. Cl. C09K 3/18; F28D 15/00

(52) U.S. Cl. 252/70; 165/104.28

(57) ABSTRACT

A heat transport fluid includes a solvent, particles dispersed in the solvent, coating agents attached to surfaces of the particles, and organic components dispersed in the solvent. The heat transport fluid can be used for a heat transport structure that includes a first member having a first temperature, a second member having a second temperature higher than the first temperature, and a circulation device for circulating the heat transport fluid through the first member and the second member.

### CROSS REFERENCE TO RELATED APPLICATION

This application is based on Japanese Patent Application No. 2006-241582 filed on Sep. 6, 2006, the content of which is incorporated herein by reference in its entirety.

### BACKGROUND OF THE INVENTION

1. Field of the Invention

The present invention relates to a heat transport fluid, a heat transport structure, and a heat transport method.

2. Description of the Related Art

A heat transport fluid used for a heat exchanger is required to have a high heat transfer coefficient. Dr. Choi et al. discloses that a heat transfer coefficient of ethylene glycol is improved by adding a small amount of nano (submicron) cluster in “Anomalously increased effective thermal conductivities of ethyleneglycol-based nanofluids containing copper nanoparticles, Applied Physics Letters, 2001, vol. 78, pp. 718-720.” However, recently, the transport fluid is required to have a higher heat transfer coefficient.

### SUMMARY OF THE INVENTION

In view of the foregoing problems, it is an object of the present invention to provide a heat transport fluid, a heat transport structure, and a heat transport method having a high heat transfer coefficient.

A heat transport fluid according to an aspect of the invention includes a solvent, particles dispersed in the solvent, coating agents attached to surfaces of the particles, and organic components dispersed in the solvent.

In this transport fluid, a change between a structured state and an unstructured state is a phase change, and an energy level of the unstructured state is higher than that of the structured state by an energy corresponding to the phase change. Thus, the heat transport fluid phase-changes in accordance with the temperature. Accordingly, this heat transport fluid has a high heat transfer coefficients.

For example, the organic components may include an organic substance having at least a sulfur atom, a straight-chain organic substance, a cyclic organic substance, an organic substance having a disulfide, an organic substance having a quaternary ammonium, or an organic substance having a primary amine. For example, the organic substance having a disulfide may have a straight-chain molecular structure or may have a carbon number in a range from 8 to 36. Alternatively, the organic substance having a disulfide may include octadecyl disulfide.

Alternatively, the coating agents may include an organic substance having at least a sulfur atom, a straight-chain organic substance, or a cyclic organic substance. For example, an average particle size of the particles may be 10 nm or smaller. The particles may be made of an inorganic material or a metal.

The solvent may be water. In this case, the particles are made of gold, and the coating agents are made of a compound having a hydrophilic group. Alternatively, the solvent may be toluene. In this case, the particles are made of gold, and the coating agents are made of a compound having a hydrophobic group.

The heat transport fluid may be used for a heat transport structure that includes a first member having a first temperature, a second member having a second temperature higher than the first temperature, and a circulation device for circulating the heat transport fluid through the first member and the second member.

Furthermore, the heat transport fluid may be used for a heat transport method that includes a step of preparing a first member having a first temperature, a step of preparing a second member having a second temperature higher than the first temperature, and a step of circulating the heat transport fluid through the first member and the second member, for transporting heat from the second member to the first member.

### BRIEF DESCRIPTION OF THE DRAWINGS

Additional objects and advantages of the present invention will be more readily apparent from the following detailed description of preferred embodiments when taken together with the accompanying drawings. In the drawings:

FIGS. 1A and 1B are schematic diagrams respectively showing an example of a structured state and an unstructured state of a heat transport fluid according to a first embodiment of the invention;

FIGS. 2A and 2B are schematic diagrams respectively showing another example of a structured state and an unstructured state of the heat transport fluid according to the first embodiment;

FIG. 3 is a graph showing organic contents in heat transport fluids according to an example of the first embodiment (FE) and a comparative example (CE);

FIG. 4 is a graph showing thermal conductivity ratio of the heat transport fluids according to the example of the first embodiment (FE) and the comparative example (CE) to toluene; and

FIG. 5 is a schematic diagram showing a cooling device according to an example of a second embodiment of the invention.

### DETAILED DESCRIPTION OF THE PREFERRED EMBODIMENTS

### First Embodiment

A heat transport fluid 19 according to a first embodiment of the invention includes a solvent, particles 1 dispersed in the solvent, coating agents 7 attached to surfaces of the particles 1, and organic components 3.

When a temperature of the heat transport fluid 19 is a first predetermined temperature or lower, the organic components 3 are structured. In contrast, when the temperature is equal to or higher than a second predetermined temperature, which is higher than the first temperature, the organic components 3 are unstructured. Thereby, the heat transport fluid 19 changes between a structured state and an unstructured state in accordance with the temperature of the heat transport fluid within a working temperature range.

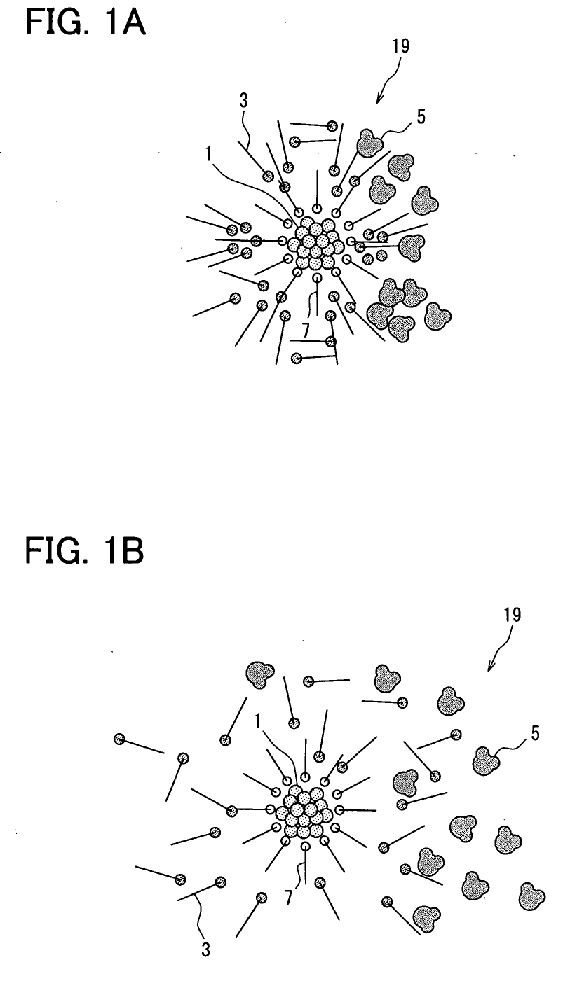

Specifically, when the temperature is the first predetermined temperature or lower within the working temperature range (e.g., from about −30 to 150° C.), the organic components 3 are arranged on the surfaces of the particles 1, thereby solvent elements 5 (solvent molecules) are also arranged on the surfaces of the particles 1 (i.e., the structured state), as shown in FIG. 1A. In contrast, when the temperature is the second predetermined temperature or higher within the working temperature range, the organic components 3 are not arranged on the surfaces of the particles 1 and move in a random manner, thereby the solvent elements 5 (solvent molecules) are not arranged on the surfaces of the particles 1 and move in a random manner (i.e., the unstructured state), as shown in FIG. 1B.

A change of the heat transport fluid 19 between the structured state and the unstructured state is a phase change, and an energy level of the unstructured state is higher than that of the structured state by an energy corresponding to the phase change. Thus, the heat transport fluid 19 phase-changes in accordance with the temperature.

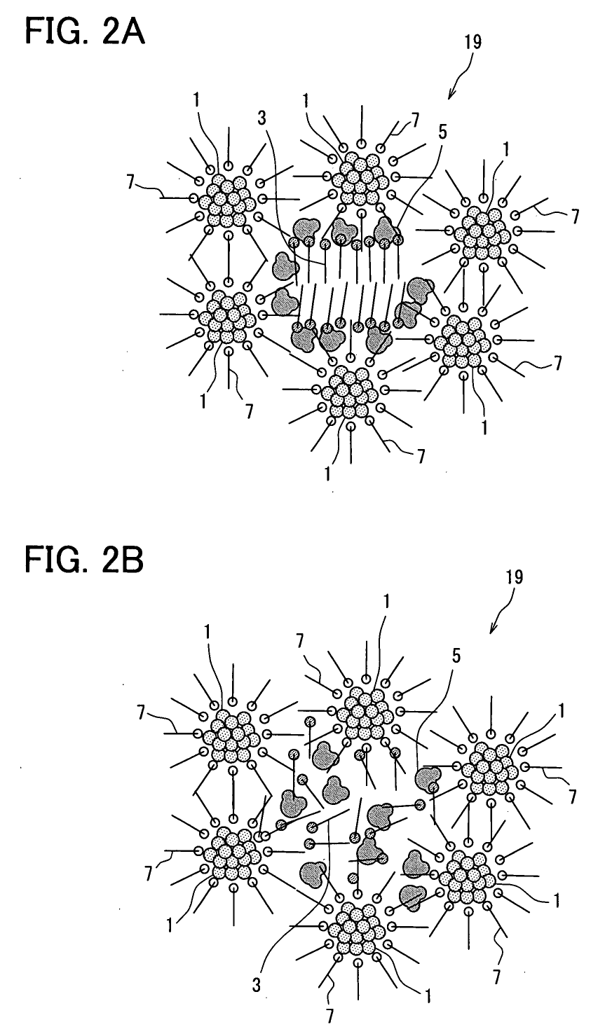

In the structured state, the organic components 3 and the solvent elements 5 may be arranged in an area surrounded by the particles 1, as shown in FIG. 2A. Alternatively, in the unstructured state, the organic components 3 and the solvent elements 5 may move in a random manner in the area surrounded by the particles 1, as shown in FIG. 2B.

Temperatures between which the heat transport fluid 19 phase-changes (i.e., the first predetermined temperature and the second predetermined temperature) may be controlled in accordance with the working temperature range. The temperature under which the phase change occurs is changed in accordance with materials and contents of the organic components 3, the particles 1, and the solvent, for example.

As the material of the organic components 3, an organic substance having at least a sulfur atom, a straight-chain organic substance, a cyclic organic substance, an organic substance having a quaternary ammonium, an organic substance having a primary amine, an organic substance having a disulfide (e.g., having a straight-chain molecular structure), n-octadecanoic thiol, or mercaptosuccinic acid may be used, for example. The organic substance having a disulfide includes octadecyl disulfide having a carbon number of 18, for example.

The heat transport fluid 19 includes the coating agents 7 attached to the surfaces of the particles 1, thereby the particles 1 can be stably dispersed in the solvent. As a material of the coating agents 7, an organic substance having at least a sulfur atom, a straight-chain organic substance, a cyclic organic substance, an organic substance having a quaternary ammonium, an organic substance having a primary amine, n-octadecanoic thiol, or a mercaptosuccinic acid may be used, for example. The organic components 3 and the coating agents 7 may be made of the same material or different materials. Alternatively, the organic components 3 may include the same material as the coating agents 7 and an additional material. When the organic components 3 and the coating agents 7 are made of the same material, a content of the material is set to be the sum of a content required for coating the surfaces of the particles 1 and functioning as the coating agents 7, and a content required for functioning as the organic components 3.

A preferred average particle size of the particles 1 is 10 nm or smaller. A lower limit of the average particle size is not determined but preferred to be a particle size corresponding to a few atoms. As the material of the particles 1, a metal such as Au, Ag, Cu, Fe, and Ni, an inorganic material such as Si and F, an oxide such as Al₂O₃, MgO, CuO, Fe₂O₃, and TiO, or a polymer made of a resin may be used, for example. The particles 1 may be made of two or more materials. Specifically, a part of the particles 1 may be made of different material with another part of the particles 1.

The material of the solvent includes at least one of water, toluene, and ethylene glycol, for example. An example of a combination of the solvent, the particles 1, and the coating agents 7 includes water as the solvent, the particles 1 made of Au, and the coating agents 7 made of a composition having a hydrophilic group such as mercaptosuccinic acid, for example. Another example of the combination includes toluene as the solvent, the particles 1 made of Au, and the coating agents 7 made of a composition having a hydrophobic group such as n-octadecanoic thiol. The heat transport fluid 19 may further include a freezing-point depressant such as potassium acetate.

A manufacturing method of a heat transport fluid FE according to an example of the first embodiment will be described below. At first, 50 ml of 30 mmol/L HAuCl₄ aqueous solution is added to a solution, in which 3.75 mmol of tetraoctylammonium bromide is added to 100 ml of toluene, and is stirred sufficiently. Next, 4.5 mmol of octadecanoic thiol is added to the solution and is stirred sufficiently. Then, a solution including 15 mmol of NaBH₄ is added, and is stirred sufficiently. At last, surplus tetraoctylammonium bromide and octadecanoic thiol are removed by using methanol or ethanol.

This manufacturing method is called a two-phase reduction method (Brust method). In this method, octadecanoic thiol is added to the solution by three times more than Au. The heat transport fluid FE formed by this method includes toluene as the solvent, the particles 1 made of Au, octadecanoic thiol as the coating agents 7, and octadecyl disulfide as the organic components 3. In the heat transport fluid FE, the particles 1 have the average particle size about 2 nm.

Next, a thermal quantity of the heat transport fluid FE is measured with a differential scanning calorimeter about in a range from −30 to 60° C. at a rate about 5° C./min. As a result, the thermal quantity of the heat transport fluid FE changes about in a range from 10 to 25° C. Here, the temperatures between which the thermal quantity changes correspond to the temperatures between which the heat transport fluid FE phase-changes.

Additionally, thermal conductivities of the heat transport fluid FE and toluene as a reference are measured by a thin wire method. At first, a metal thin wire (e.g., a Pt wire having a diameter about 50 μm) is strained in a sufficiently large measuring medium (e.g., about 20 mm in diameter). Then, a predetermined amount of a thermal flow is generated by current heating from a time t=0 and flows out from a surface of the thin wire. The predetermined thermal flow is set so that a temperature of the thin wire increases about by 1° C. during a measurement (i.e., from about 0.3 to 0.6 A in current value). The temperature of the thin wire increases with time in accordance with a formula including thermal properties of the measuring medium such as the thermal conductivity and a specific heat. Thus, the thermal conductivity can be obtained by measuring an increase of the temperature and applying the measured value to the formula.

A thermal conductivity ratio (λ1/λ2) of the heat transport fluid FE to toluene is calculated based on a thermal conductivity (λ1) of the heat transport fluid FE and a thermal conductivity (λ2) of toluene measured by the above-described method. As shown in FIG. 4, the heat transport fluid 19 has a high thermal conductivity.

Next, a heat transport fluid CE according to a comparative example is manufactured as described below. At first, Au nano particles coated by polyvinylpyrrolidone are prepared. Next, polyvinylpyrrolidone as a ligand is exchanged for octadecanoic thiol. Then, surplus octadecanoic thiol is removed by using methanol or ethanol.

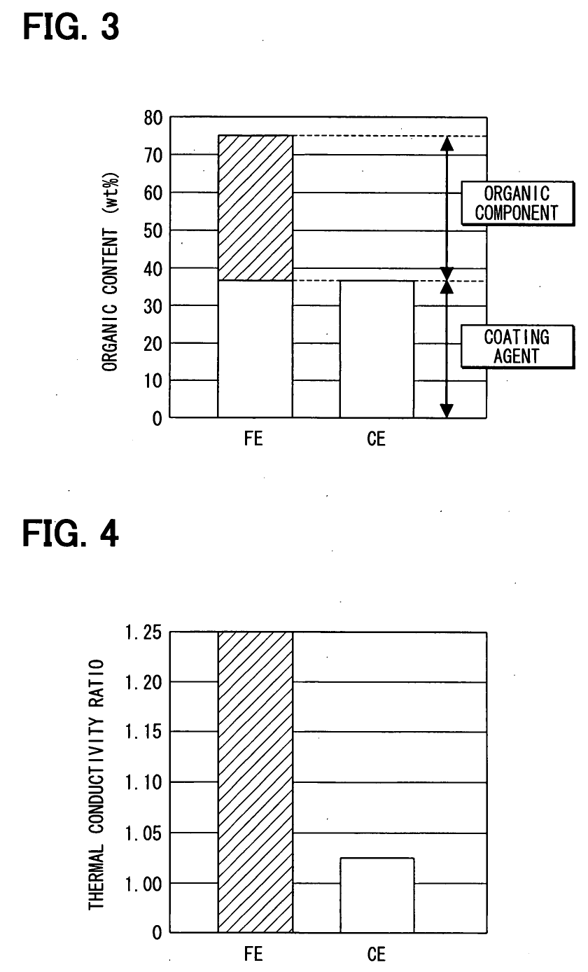

The heat transport fluid CE includes toluene as the solvent, the particles 1 made of Au, and octadecanoic thiol as the coating agents 7, but does not include the organic components 3, which is included in the heat transport fluid FE. Therefore, an organic content of the heat transport fluid CE is lower than that of the heat transport fluid FE by the content of the organic components 3, as shown in FIG. 3.

A thermal quantity of the heat transport fluid CE is measured with the differential scanning calorimeter. A change of the thermal quantity is smaller than that of the heat transport fluid FE. Thus, the heat transport fluid CE does not phase-change even when the temperature changes.

Additionally, a thermal conductivity (λ3) of the heat transport fluid CE and the thermal conductivity (λ2) of toluene as the reference are measured, and a thermal conductivity ratio (λ3/λ2) of the heat transport fluid CE to toluene is calculated. As shown in FIG. 4, the thermal conductivity ratio of the heat transport fluid CE is lower than that of the heat transport fluid FE by a great difference, which cannot be explained by a difference in the organic contents in FIG. 3.

### Second Embodiment

A heat transport structure according to a second embodiment of the invention includes a first member having a first temperature and a second member having a second temperature higher than first temperature, and circulation device for circulating a heat transport fluid through the first member and the second member. When the first temperature is lower than the first predetermined temperature of the first embodiment, and the second temperature is higher than the second predetermined temperature of the first embodiment, a heat transfer coefficient of the heat transport structure is improved by using the heat transport fluid 19 according to the first embodiment.

Specifically, when the heat transport fluid 19 in the structured state flows into the second member having the second temperature higher than the second predetermined temperature, the heat transport fluid 19 receives a heat corresponding to the phase change in addition to a heat due to a normal thermal conduction, thereby the heat transport fluid becomes the unstructured state having a high energy level, as shown in FIG. 1B, for example. In contrast, when the heat transport fluid 19 flows into the first member having the first temperature lower than the first predetermined temperature, the heat transport fluid 19 releases the heat corresponding to the phase change in addition to a heat due to a normal thermal conduction, thereby the heat transport fluid 19 becomes the structured state, as shown in FIG. 1A, for example. Thus, the heat transport fluid 19 has a pseudo latent heat transport effect, that is, the heat transport fluid 19 receives a thermal quantity corresponding to the phase change from the second member, and releases the thermal quantity to the first member. Thereby, the heat transfer coefficient of the heat transport fluid 19 increases.

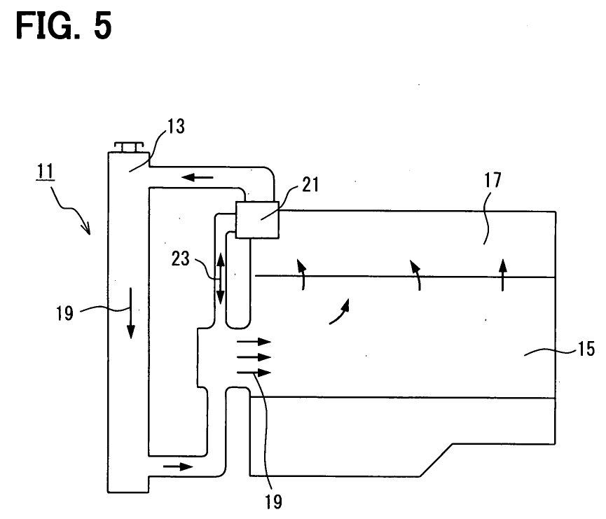

This heat transport structure can be used for a cooling device 11 for a vehicular engine, for example. As shown in FIG. 5, the cooling device 11 has a radiator 13, a cylinder block 15, and a cylinder head 17. The heat transport fluid 19 according to the first embodiment is circulated in the cooling device 11 in this order by a pump (not shown). The cooling device 11 also has a thermostat 21 and a bypass 23 at an outlet of the cylinder head 17. The thermostat 21 controls an amount of the heat transport fluid 19 flowing into the bypass 23 in accordance with a temperature of the heat transport fluid 19 detected therein. The heat transport fluid 19 receives a heat from the cylinder block 15 and the cylinder head 17, which are heated by a heat of the vehicular engine, and releases the heat to the radiator 13 cooled by outside air.

The cylinder block 15 and the cylinder head 17 have temperatures higher than a temperature under which the phase change of the heat transport fluid 19 occurs, and the radiator 13 has a temperature lower than the temperature under which the phase change occurs. Therefore, when the heat transport fluid 19 flows into the cylinder block 15 and the cylinder head 17, the heat transport fluid 19 receives the heat corresponding to the phase change in addition to heat due to a normal thermal conduction, thereby the heat transport fluid 19 is in a high energy level and becomes the unstructured state. In contrast, when the heat transport fluid 19 flows into the radiator 13, the heat transport fluid 19 releases the heat corresponding to the phase change in addition to the heat due to the normal thermal conduction, thereby the heat transport fluid 19 becomes the structured state. Thus, the heat transport fluid 19 has the pseudo latent heat transport effect, thereby the heat transfer coefficient of the heat transport fluid 19 increases. As a result, the cooling device 11 has a high heat transfer coefficient.

Such changes and modifications are to be understood as being within the scope of the present invention as defined by the appended claims.

What is claimed is:

1. A heat transport fluid comprising:
a solvent;
particles dispersed in the solvent;
coating agents attached to surfaces of the particles; and
organic components dispersed in the solvent.

2. The heat transport fluid according to claim 1, wherein:
the organic components include an organic substance having at least a sulfur atom.

3. The heat transport fluid according to claim 1, wherein:
the organic components include at least one of a straight-chain organic substance and a cyclic organic substance.

4. The heat transport fluid according to claim 1, wherein:
the organic components include an organic substance having a disulfide.

5. The heat transport fluid according to claim 4, wherein:
the organic substance has a straight-chain molecular structure.

6. The heat transport fluid according to claim 4, wherein:
the organic substance has a carbon number in a range from 8 to 36.

7. The heat transport fluid according to claim 4, wherein:
the organic substance includes octadecyl disulfide.

8. The heat transport fluid according to claim 1, wherein:
the organic components include an organic substance having a quaternary ammonium.

9. The heat transport fluid according to claim 1, wherein:
the organic components include an organic substance having a primary amine.

10. The heat transport fluid according to claim 1, wherein:
the coating agents include an organic substance having at least a sulfur atom.

11. The heat transport fluid according to claim 1, wherein:
the coating agents include at least one of a straight-chain organic substance and a cyclic organic substance.

12. The heat transport fluid according to claim 1, wherein:
an average particle size of the particles is 10 nm or smaller.

13. The heat transport fluid according to claim 1, wherein:
the particles are made of an inorganic substance.

14. The heat transport fluid according to claim 1, wherein:
the particles are made of a metal.

15. The heat transport fluid according to claim 1, wherein:
the solvent includes water;
the particles are made of gold; and
the coating agents are made of a compound having a hydrophilic group.

16. The heat transport fluid according to claim 1, wherein:
the solvent includes toluene;
the particles are made of gold; and
the coating agents are made of a compound having a hydrophobic group.

17. A heat transport structure comprising:
a first member having a first temperature;
a second member having a second temperature higher than the first temperature; and
a circulation device for circulating the heat transport fluid according to claim 1, through the first member and the second member.

18. A method of heat transport comprising:
preparing a first member having a first temperature;
preparing a second member having a second temperature higher than the first temperature; and
circulating the heat transport fluid according to claim 1, through the first member and the second member, for transporting heat from the second member to the first member.

19. The heat transport fluid according to claim 1, wherein:
the organic components are arranged around the surfaces of the particles attached with the coating agents when a temperature of the heat transport fluid is equal to or lower than a first predetermined temperature; and
the organic components move in a random manner when the temperature of the heat transport fluid is equal to or higher than a second predetermined temperature that is higher than the first predetermined temperature.

20. The heat transport fluid according to claim 1, wherein:
the organic components are arranged in an area surrounded by the particles when a temperature of the heat transport fluid is equal to or lower than a first predetermined temperature; and
the organic components move in a random manner in the area surrounded by the particles when the temperature of the heat transport fluid is equal to or higher than a second predetermined temperature that is higher than the first predetermined temperature.
